(19) United States
(12) Patent Application Publication
(10) Pub. No.: US 2002/0061185 A1
(43) Pub. Date: May 23, 2002

(54) Apparatus and method for recording video data

(76) Inventors: Hirotada Hirabayashi, Ome-shi (JP); Seiichi Nakamura, Inagi-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/950,680

(22) Filed: Sep. 13, 2001

(30) Foreign Application Priority Data
Nov. 17, 2000 (JP) 2000-351607

(51) Int. Cl. H04N 5/76; G11B 15/04; G11B 19/04; H04N 7/167

(52) U.S. Cl. 386/94; 360/60; 380/201

(57) ABSTRACT

An apparatus includes a video recorder con figured to record video data demanded to be recorded by user in a storage device. The apparatus further includes a identifying unit for identifying the user who has demanded the recording of the video data, and a unit for executing a concealing process, using information assigned to the identified user. The concealing process prevents the video data recorded in the storage device from being reproduced by a person other than the user who has demanded the recording of the video data.

### CROSS-REFERENCE TO RELATED APPLICATIONS

This application is based upon and claims the benefit of priority from the prior Japanese Patent Application No. 2000-351607, filed Nov. 17, 2000, the entire contents of which are incorporated by reference.

### BACKGROUND OF THE INVENTION

1. Field of the Invention

The present invention relates to an apparatus and method for recording video data such as TV programs.

2. Description of the Related Art

In accordance with the widespread use and sophistication of personal computers, various proposals have been recently made for new uses of the computers at home. To give a typical example, some personal computers have a function of recording and reproducing TV programs.

The TV recording/reproducing function enables the personal computers to be used in place of TV sets or VCRs, etc. AV (Audio Video) data on a TV program received by a TV tuner is displayed on the display monitor of a computer and also stored in a large-capacity, high-speed storage device, such as a hard disk drive, incorporated in the computer. The hard disk drive can store a large number of TV programs, by digital compression, using a moving image coding method such as MPEG-2 (MPEG: Moving Picture Coding Experts Group).

When necessary, the TV programs stored in the hard disk drive can be edited on the computer or reproduced and displayed on the display monitor.

However, these functions are commonly provided assuming one user per personal computer. No consideration is given to the use of a single personal computer in, for example, a multi-user environment, in which every member of a family uses a single computer as a main AV entertainment machine.

There is therefore a need for a mechanism that enables a large number of TV programs to be recorded in the hard disk drive, and enables individual privacy concerning recorded data to be protected in a multi-user environment.

### BRIEF SUMMARY OF THE INVENTION

It is an object of the present invention to provide an apparatus and a method suitable for video data recording in a multi-user environment.

According to an aspect of the present invention, there is provided an apparatus for recording video data. The apparatus comprises: a video recorder configured to record video data in a storage device; means for acquiring a user information of a person who demands the recording of the video data; and means for executing, using the user information, concealing process to prevent the video data recorded in the storage device from being reproduced by a person other than the person who demands the recording.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiment of the invention, and together with the general description given above and the detailed description of the embodiment given below, serve to explain the principles of the invention.

FIG. 1 is a block diagram illustrating an example hardware structure of a computer system according to the embodiment of the present invention;

FIG. 2 is a view useful in explaining a manner of use of the system according to the embodiment;

FIG. 3 is a block diagram illustrating the functional structure of a TV application program executed in the system of the embodiment;

FIG. 4 is a table showing the structure of user information used in the system of the embodiment;

FIG. 5 is a view useful in explaining the principle of an encryption process used in the system of the embodiment;

FIG. 6 is a flowchart illustrating a user information registration process in the system of the embodiment;

FIG. 7 is a view showing an example of a user information registration window used in the user information registration process of FIG. 6;

FIG. 8 is a flowchart illustrating a user authentication process in the system of the embodiment;

FIG. 9 is a view showing an example of a user authentication window used in the user authentication process of FIG. 8;

FIG. 10 is a view showing the basic window of a TV application program used in the system of the embodiment;

FIG. 11 is a flowchart illustrating a process executed in the system of the embodiment when the user has demanded recording;

FIG. 12 is a view showing an example of an encryption setup window used in the system of the embodiment;

FIG. 13 is a view showing an example of a record parameter setup window used in the system of the embodiment;

FIG. 14 is a flowchart illustrating a recording process in the system of the embodiment;

FIG. 15 is a flowchart illustrating another recording process in the system of the embodiment;

FIG. 16 is a flowchart illustrating a process of displaying a list of recorded TV programs in the system of the embodiment;

FIG. 17 is a view illustrating an example window that displays a list of recorded TV programs in the system of the embodiment;

FIG. 18 is a flowchart useful in explaining a reproduction process in the system of the embodiment;

FIG. 19 is a flowchart useful in explaining another reproduction process in the system of the embodiment;

FIG. 20 is a flowchart illustrating another process of displaying a list of recorded TV programs in the system of the embodiment;

FIG. 21 is a flowchart useful in explaining a process executed when using the process of displaying a list of recorded TV programs shown in FIG. 20, as a concealing process;

FIG. 22 is a view illustrating an example window that displays a list of to-be-recorded TV programs in the system of the embodiment;

FIG. 23 is a flowchart useful in explaining a process of setting to-be-recorded TV programs in the system of the embodiment;

FIG. 24 is a view showing a window used for executing the process of setting to-be-recorded TV programs shown in FIG. 23;

FIG. 25 is a view illustrating the structure of to-be-recorded data used in the system of the embodiment;

FIG. 26 is a flowchart useful in explaining a process of setting to-be-recorded TV programs in the system of the embodiment;

FIG. 27 is a flowchart useful in explaining another process of setting to-be-recorded TV programs in the system of the embodiment;

FIG. 28 is a flowchart useful in explaining yet another process of setting to-be-recorded TV programs in the system of the embodiment; and

FIG. 29 is a view illustrating another structure of the system of the embodiment.

### DETAILED DESCRIPTION OF THE INVENTION

The embodiment of the present invention will be described with reference to the accompanying drawings.

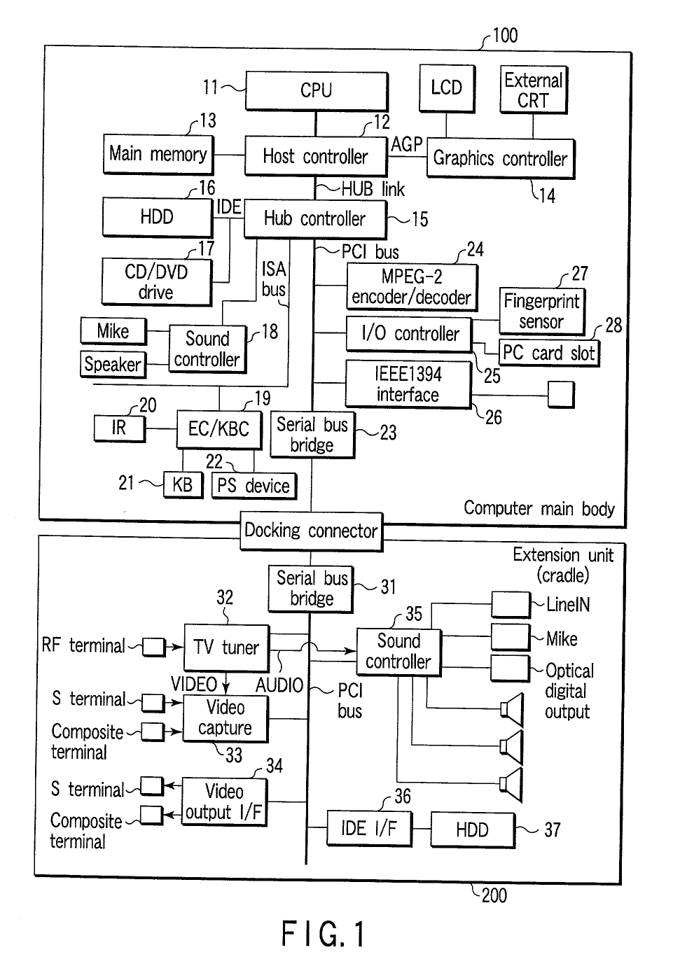

FIG. 1 shows an example structure of a computer system according to the embodiment. The computer system is a notebook-type personal computer that can be powered by a battery. Its computer main body 100 is constructed such that it can be mounted on and dismounted from a cradle-type extension unit 200 for extending the functions of the main body 100 of the computer. The computer main body 100 and the extension unit 200 are connected to each other by means of their respective docking connectors. In place of the docking connectors, the computer main body 100 and the extension unit 200 may have their respective wireless communication interfaces such as IEEE802.11 interfaces. In this case, the computer main body 100 and the extension unit 200 can communicate with each other although they are not physically connected.

As shown, the computer main body 100 comprises a CPU 11, a host controller 12, a main memory 13, a graphics controller 14, a hub controller 15, a hard disk drive (HDD) 16, a CD/DVD drive 17, a sound controller 18, an embedded/keyboard controller (EC/KBC) 19, an infrared interface (IR) 20, a keyboard (KB) 21, a pointing device 22, a serial bus bridge 23, an MPEG-2 encoder/decoder 24, an I/O controller 25, an IEEE1394 interface 26, a fingerprint sensor 27 and a PC card slot 28, etc.

The CPU 11 executes programs loaded in the main memory 13 to thereby control the operations of the computer system and various data processes. The host controller 12 and the hub controller 15 are a main chip set incorporated in the computer system, and are connected to each other by a dedicated bus called a “hub link”. The host controller 12 has, for example, a memory control logic for controlling the main memory 13, and an interface function for a video bus (AGP: Accelerated Graphics Port) connected to the graphics controller 14. The hub controller 15 includes an IDE controller, a PCI bus interface, an ISA bus interface, etc.

The HDD 16 stores an operating system (OS) and various application programs to be executed by CPU 11. In this embodiment, the HDD 16 also stores a TV application program that causes the computer system to record and reproduce AV data (audio/video data) such as TV programs. The TV application program is loaded onto the main memory 13 and executed by CPU11. The graphics controller 14 controls the display monitor of the computer system so as to display data on a display (LCD panel) openably and closably attached to the computer main body 100, or on an external CRT.

The sound controller 18 inputs and outputs sound signal using a microphone and a speaker provided on the computer main body 100. The embedded/keyboard controller (EC/KBC) 19 is formed of an LSI and includes an embedded controller EC for power management and a keyboard controller (KBC). The controller 19 also has a function of executing infrared communication with another personal computer or an external remote controller, using the infrared interface (IR) 20. The MPEG-2 encoder/decoder 24 executes encoding/decoding of various types of AV data (audio/video data), using the MPEG-2 digital compression-encoding method. The MPEG-2 encoder/decoder 24 encodes the TV program when recording a TV program using the TV application program, and decodes recorded data when reproducing recorded data using the TV application program. The MPEG-2 encoder/decoder 24 may be provided in the extension unit 200.

The I/O controller 25 has, for example, a function of controlling the fingerprint sensor 27, and a function of controlling a PC card inserted in the PC card slot 28. The fingerprint sensor 27 is used to identify the user from their fingerprints. The IEEE1394 interface 26 is a serial interface used to communicate with, for example, a video camera or an external IEEE1394 device.

The serial bus bridge 23 and a serial bus bridge 31 incorporated in the extension unit 200 are joined to serially transmit bus transactions between the respective PCI buses of the computer main body 100 and the extension unit 200. A signal line between the serial bus bridges 23 and 31 is formed of a serial line.

The extension unit 200 inputs and records a TV program in response to a request from the computer main body 100. In addition to the serial bus bridge 31, the extension unit 200 includes a TV tuner 32, a video capture 33, a video output interface 34, a sound controller 35, an IDE interface 36 and an HDD 377, etc., as is shown in FIG. 1. The TV tuner 32 receives, via an RF terminal, a TV broadcast signal input through a TV antenna, and divides it into a video data (VIDEO) signal and an audio data (AUDIO) signal. The video data signal is transmitted to the video capture 33, while the audio data signal is transmitted to the sound controller 35.

The video capture 33 executes A/D conversion on a video data signal input from an external AV device via an S terminal or a composite terminal dedicated to the capture 33, or a video data signal input from the TV tuner 32, and outputs the A/D conversion result as digital video data in the form of, for example, YUV or RGB. The video output interface 34 inputs digital video data, converts it into analog video data in the form of, for example, NTSC, and outputs the conversion result to an external TV set or video device via an S terminal or a composite terminal dedicated to the interface 34. The video output interface 34 also has a function of outputting graphics created by the graphics controller 14, to an external TV set or video device.

The sound controller 35 is used to output sound data to an external audio device or to drive a speaker system provided in the extension unit 200. The HDD 37 is a storage device mainly used to record AV data such as a TV program, and has a larger memory capacity than the HDD 16 of the computer main body 100.

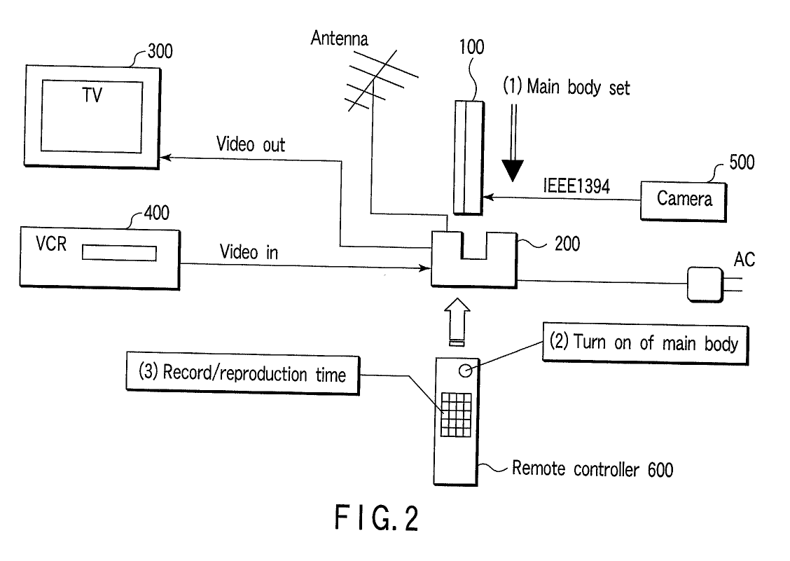

Referring then to FIG. 2, the manner of use of the computer system will be described.

The computer main body 100 is detached from the extension unit 200 when it is used to execute usual operations such as word processing, spreadsheet programming, mailing and internet accessing, etc. When recording or reproducing AV data, the computer main body 100 is attached to the extension unit 200. The ON/OFF operation of the computer main body 100 and the start of recording/reproducing, etc. can be executed by operating the keyboard 21 or a remote control unit 600. When it is attached to the extension unit 200, the computer main body 100 can be driven by power supplied from an AC adaptor connected to the extension unit 200.

As shown in FIG. 2, the extension unit 200 can be connected to a TV set 300, a VCR (Video Cassette Recorder) 400 and a TV antenna, and can record a TV program received from the antenna, or video data input from the VCR 400, or reproduce recorded data on the TV set 300. Further, video data obtained by an external video camera 500 can be input to the computer main body 100 via the IEEE1394 interface, and recorded like TV programs.

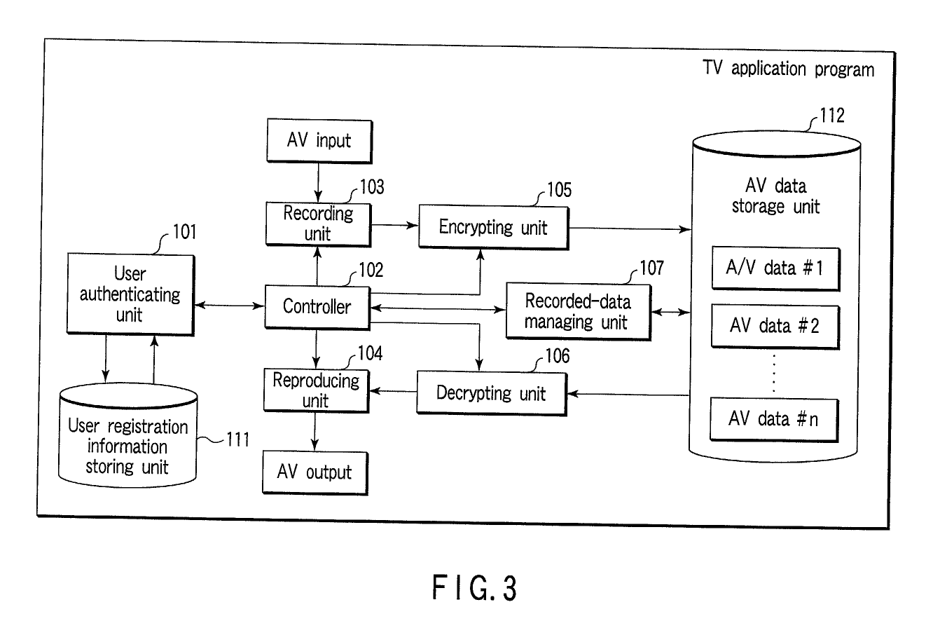

Referring now to FIG. 3, a description will be given of the structure of the TV application program used in the embodiment.

To enable each member of a family to record/reproduce AV data using the computer system, with their privacy protected, the TV application program comprises a user-authenticating unit 101, a controlling unit 102, a recording unit 103, a reproducing unit 104, an encrypting unit 105, a decrypting unit 106 and a recorded data managing unit 107, etc. The each of units is comprised of instructions within the TV application program.

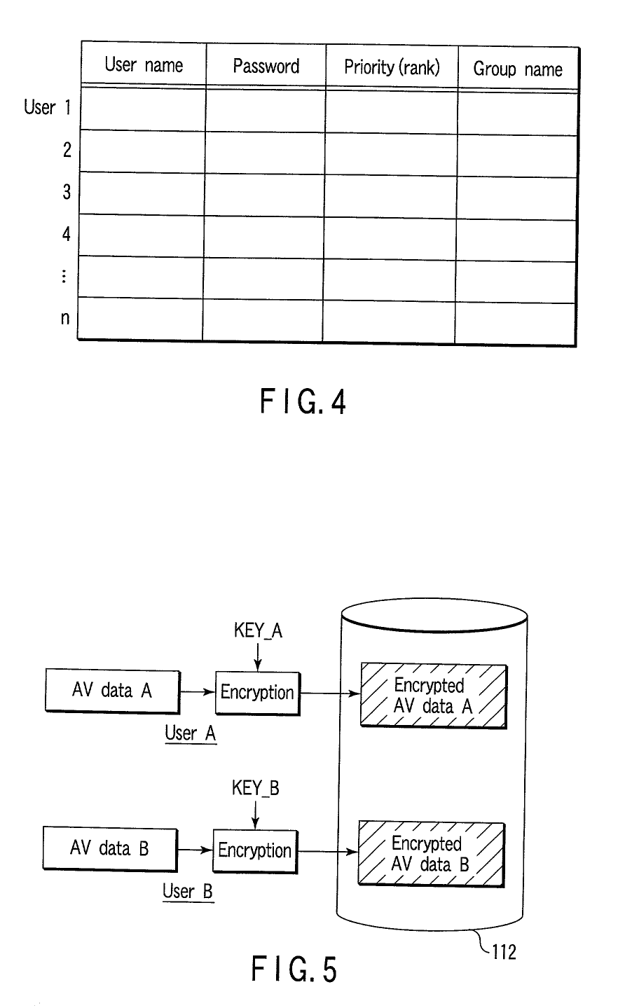

The user-authenticating unit 101 executes an identification process for authenticating and identifying a user who has requested the recording/reproducing of AV data using the computer system. The process is executed, using personal information for identification assigned to each user (e.g. all members of a family) and pre-registered in a user registration information-storing unit 111. As shown in FIG. 4, the personal information includes a user name, a password, a priority (rank) and a group name. The priority (rank) data is used to determine a TV program to be recorded at the highest priority when, for example, the date and hour of a TV program set by a user is identical to that of a TV program set by another user or other users. The group name data is used when managing some users as one group. The control using the group name data will be described later in detail.

The controlling unit 102 controls the entire process of recording and reproducing AV data, and specifically executes a function of registering the personal information, a function of managing the schedule of to-be-recorded data set by the users, and a function of managing the encryption/decryption of recorded data on the basis of a user identification result, etc.

The recording unit 103 inputs AV data on, for example, a TV program having its recording demanded by a user, and records it in an AV data storage unit 112. The AV data storage unit 112 is formed of, for example, the HDD 37 of FIG. 1. AV data demanded to be record is input by video data input devices such as the TV tuner 32, the video capture 33 and the sound controller 35. The recording unit 103 uses the MPEG-2 encoder/decoder 24 to subject the input AV data to compression encoding, thereby converting it into recording data and supplying the resultant data to the encrypting unit 105.

The encrypting unit 105 is provided to execute a concealing process for preventing a user, other than the user having demanded the recording of AV data, from reproducing the AV data. Specifically, it encrypts (by, for example, scrambling) the content of the AV data outputted from the recording unit 103. This encryption is executed using, for example, a common key cryptography. In this case, the controlling unit 102 controls the encryption by the encrypting unit 105 so that different encryption keys (common keys) are used for different users or groups.

To this end, the controlling unit 102 manages a user ID/group ID assigned to each registered user name/group name. On the basis of the user identification result from the user authentication unit 101, the controlling unit 102 identifies the user having demanded recording, and supplies the encrypting unit 105 with the user ID/group ID assigned to the identified user and serving as an encryption key. FIG. 5 illustrates the encryption process. As seen from FIG. 5, AV data (A) having its recording demanded by user (A) is subjected to encryption using encryption key (KEY_A) corresponding user (A), and the resultant encrypted AV data (A) is recorded in the AV data storage unit 112. Similarly, AV data (B) having its recording demanded by user (B) is subjected to encryption using encryption key (KEY_B) corresponding user (B), and the resultant encrypted AV data (B) is recorded in the AV data storage unit 112.

The reproducing unit 104 reproduces recorded AV data having its reproduction demanded by a user. Specifically, the unit 104 uses the MPEG-2 encoder/decoder 24 to decode (extend) AV data read from the AV data storage unit 112, thereby outputting the decoded video and audio data to an external TV set and the speaker of the extension unit 200, respectively. If the AV data demanded to be reproduced by a user is encrypted, the decrypting unit 106 decrypts the data. In this decrypting process, the user ID/group ID corresponding to the user or group having demanded the reproduction is used as a key for releasing the encryption. If user (A) demands the reproduction of the encrypted AV data (A), key (KEY_A) corresponding user (A) is used to decrypt the encrypted AV data (A). But if user (B) demands the reproduction of the encrypted AV data (A), key (KEY_B) corresponding user (B) is used to decrypt the encrypted AV data (A). Accordingly, if the user who recorded data reproduces the data, the encryption of the recorded data can be released. However, the other users cannot release the encryption.

The recorded data managing unit 107 manages, for each recorded AV data item, video management information that includes information concerning its encryption, attribute information such as its title, its representative still image and the start/finish date and time of its recording, etc. and information indicating, for example, the relationship between the data and the user having demanded its recording. From the video management information, it can be recognized what kinds of AV data items are recorded, whether or not each AV data item is encrypted, or who recorded each AV data item.

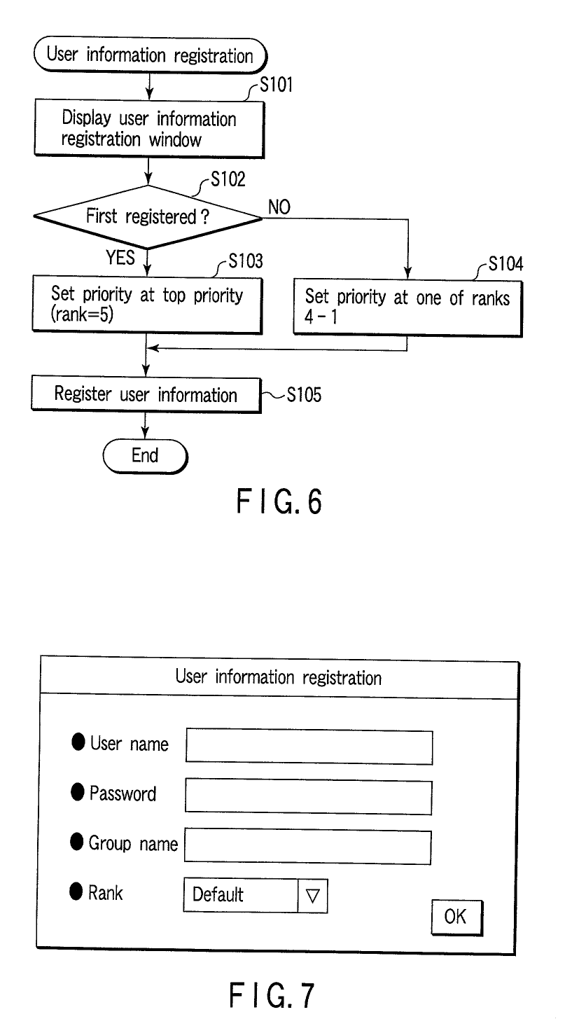

Referring then to the flowchart of FIG. 6, a description will be given of a user information registration process executed by the controlling unit 102.

The user information registration process is a tool included in the TV application program, and is read and executed by CPU 11.

The controlling unit 102 in the TV application program displays a user information registration window as shown in FIG. 7 on the display panel of the computer main body 100 or on the external TV set 300. The users use the window to input user information (step S101). As shown in FIG. 7, the user information registration window has, for example, a user name input field, a password input field, a group name input field and a rank input field, etc. When any user has input information in these fields and pushed the “OK button”, user information is set in the user registration information storing unit 111. In this case, the value to be input in the rank input field is normally a “default value”, and an optimal rank (priority order) is automatically set.

If, for example, no user information is registered in the user registration information storing unit 111 so far, and this is the first user information registration (if the answer at step S102 is YES), the controlling unit 102 sets the priority order of the user at the top priority (rank=5) (step S103).

On the other hand, if the present information registration is the second or later registration (if the answer at the step S102 is NO), the controlling unit 102 sets the priority of the user at a predetermined rank (e.g. rank=3) included in ranks 4-1 (step S104). It is a matter of course that the user can select any one of the ranks 4-1 by operating the pull-down menu of the rank input field. Further, the rank may be automatically reduced one by one in the order of registration of the user information, or may be automatically set on the basis of the input user name or group name. For example, ranking suitable for the structure of a family may be executed by setting the group names at “child”, “student” and “adult”, etc.

Thus, personal information for each user of the computer system of the embodiment, which consists of information groups as shown in FIG. 4, is registered in the user registration information storing unit 111 (step S105).

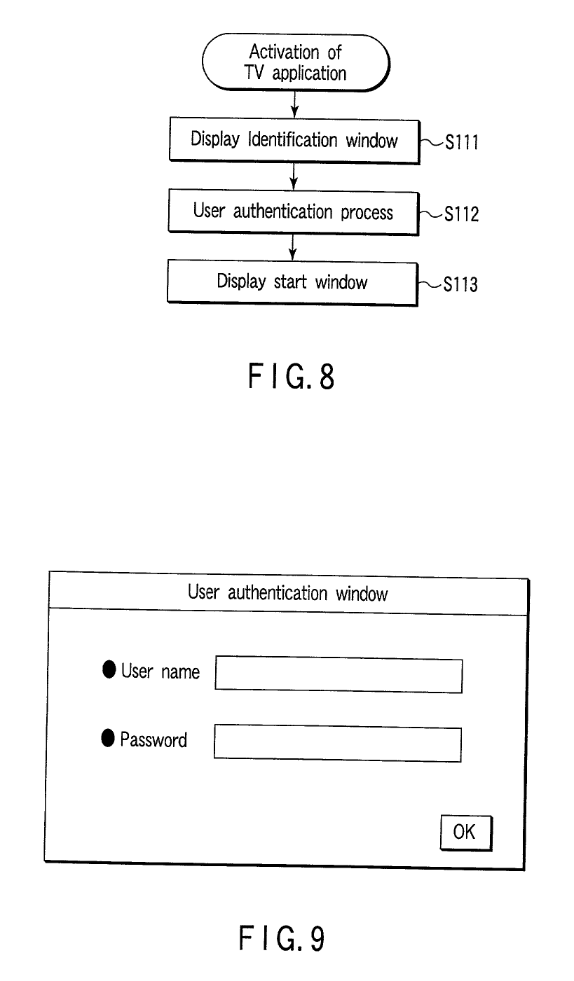

Referring then to the flowchart of FIG. 8, the user identifying process executed by the user authenticating unit 101 will be described.

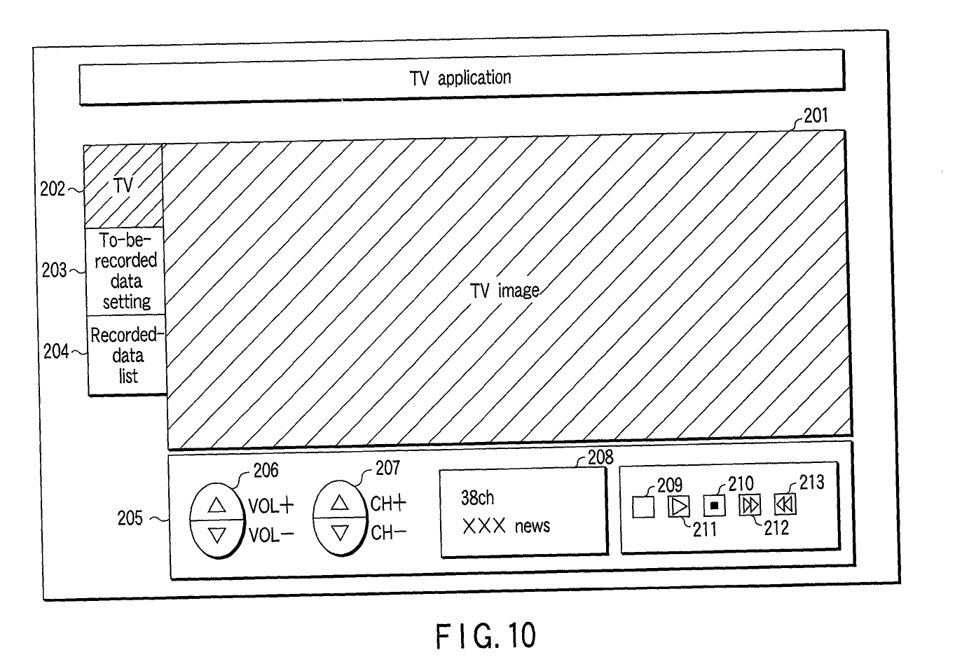

The user identifying process is executed, to determine the user who currently uses the computer system, when activating the TV application program, for example. The user authenticating unit 101 first displays a user identification window, as shown in FIG. 9, on the display panel of the computer main body 100 or on the external TV set 300. The users use the window to input information for identification (step S111). The user identification window has, for example, a user name input field and a password input field. When any user has input their user name and password and pushed the “OK button”, the user identification process is started (step S112). The user who currently uses the computer system is determined by comparing the input information with the user information stored in the user registration information storing unit 111. If the user pushes the “OK button” without inputting their user name or password, the user is considered as a guest user. The guest user can use the computer system with the functions limited. After finishing the user identification process, the controlling unit 102 displays a start window on the display panel of the computer main body 100 or on the external TV set 300 (step S113). FIG. 10 shows an example of the start window.

As shown in FIG. 10, this window includes a main window 201, a “TV” tab 202, a “to-be-recorded data setting (programming of record TV programs)” tab 203 and a “recorded-program list” tab 204, a control window 205. When the “TV” tab 202 has been pushed, the main window 201 displays a TV program broadcasted through the currently selected channel. The “to-be-recorded data setting” tab 203 is used to set a to-be-recorded TV program (recording schedule) in the computer system. The “recorded-program list” tab 204 is used to display a list of recorded TV programs. The control window 205 has a volume button 206, a channel button 207, a status window 208, a “stop” button 209, a “play” button 210, a “record” button 211, a “fast-forward” button 212 and a “fast-reverse” button 213. The status window 208 displays the channel number or the title of a currently reproduced TV program on the basis of information such as an electronic program guide (EPG) pre-downloaded from the Internet.

The “record” button 211 is used to instruct the system to record a TV program currently reproduced/displayed on the main window 201. The “play” button 210 is used to instruct the system to play (reproduce) display a recorded TV program.

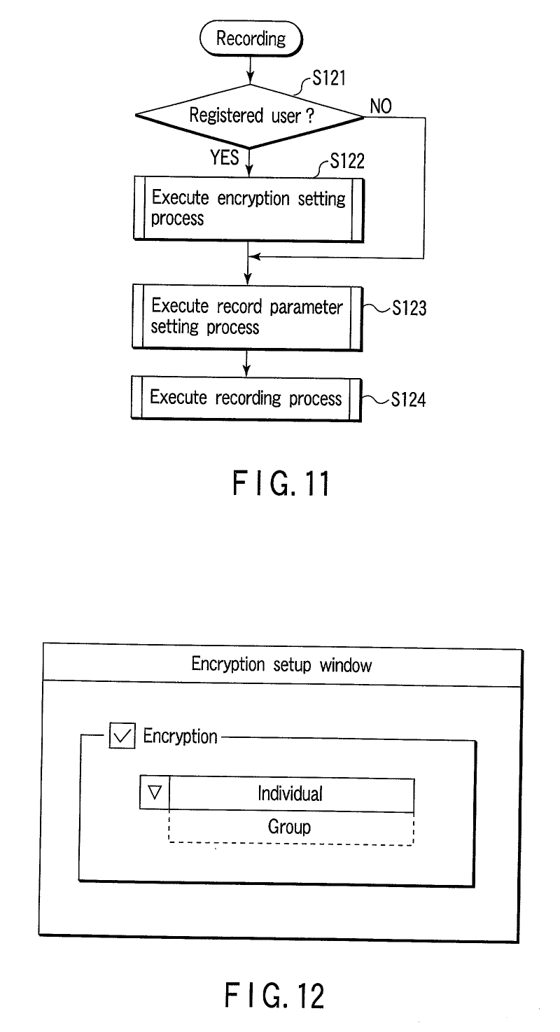

Referring to the flowchart of FIG. 11, the process executed when the “record” button 211 has been pushed will be described.

When the user has pushed the “record” button 211, the controlling unit 102 first identifies the user who currently uses the TV program, and determines whether or not the user is included in the users whose personal information is registered in the user registration information storing unit 111 (step S121). This determination process is executed on the basis of the result of the user identifying process executed when the TV application program has been activated. It is a matter of course that the user identifying process may be again executed after the “record” button 211 has been pushed.

If it is determined that the user is a registered user (if the answer at the step S121 is YES), the controlling unit 102 executes an encryption setup process using an encryption setup window as shown in FIG. 12 (step S122). In this encryption setup process, it is set whether or not the TV program should be encrypted, and whether the encryption process should be executed in an “individual” or “group” mode. If the user checks the check box for “encryption” in the encryption setup window of FIG. 12, the TV program is encrypted. If, in this case, the “individual” mode is selected, the user ID of the user is used as an encryption key. If, on the other hand, the “group” mode is selected, the group ID of the user is used as the encryption key. If encryption is executed in the “individual” mode, no one other than the user who recorded the data can reproduce the encrypted recorded data. However, if encryption is executed in the “group” mode, any one belonging to the same group as the user who recorded the data can reproduce the encrypted recorded data.

If the user is not a registered one, i.e. if the user is a guest user (if the answer at the step S121 is NO), the encryption setup process at the step S122 is skipped and no encryption is executed.

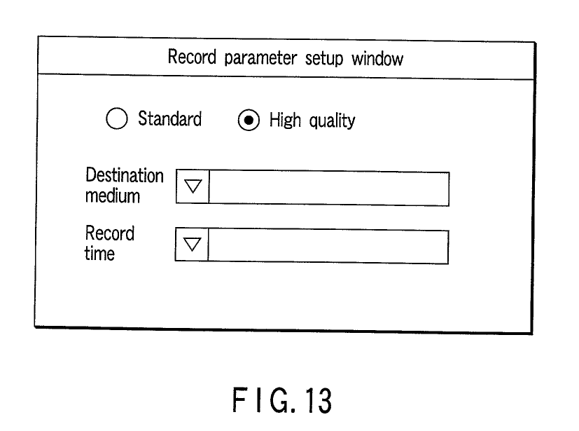

Subsequently, the controlling unit 102 displays a record parameter setup window, as shown in FIG. 13, on the display panel of the computer main body 100 or on the external TV set 300, thereby enabling the setup of an image quality (standard, high quality), a medium in which data is to be recorded, and a recording period of time, etc. (step S123). The DVD drive 17, as well as the HDD 13, can be designated as the medium. The recording period can be set at a value selected in accordance with the time period of a to-be-recorded TV program. After that, the controlling unit 102 starts an actual recording process on the basis of the contents set at the steps S122 and S123 (step S124).

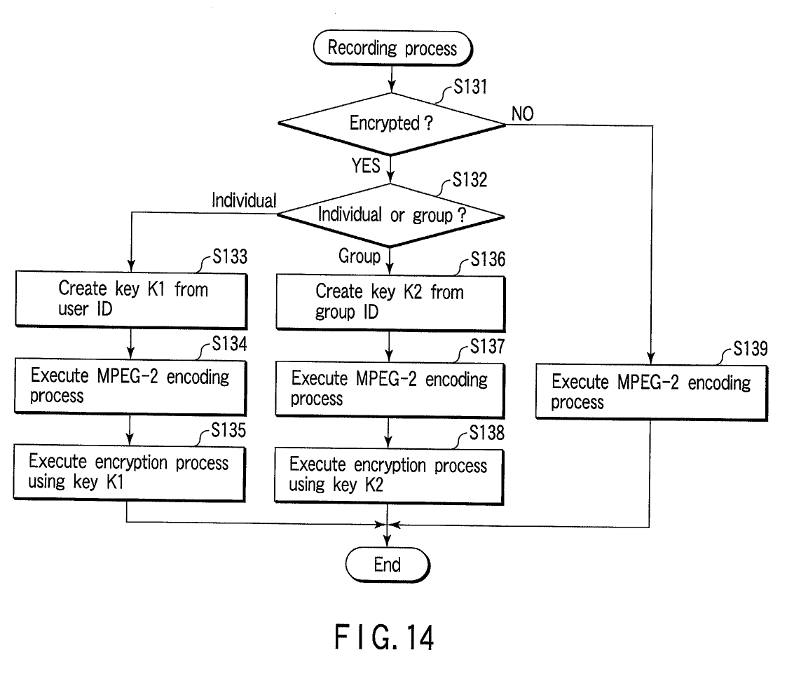

FIG. 14 shows an example of the recording process.

At first, it is determined, from the contents set in the above-described encryption setup process, whether or not encryption should be executed (step S131). When executing the encryption process, it is also determined whether the encryption process is executed in the “individual”, or “group” mode (step S132). If it is determined that the encryption process is executed in the “individual”, mode, encryption key (K1) is created from the user ID of the present user (step S133). The user ID itself may be used as the encryption key (K1). Subsequently, a bit rate corresponding to the designated image quality is determined, thereby executing MPEG-2 encoding so as to obtain encoded data of an amount corresponding to the bit rate (step S134). The content of encoded data is subjected to encryption using the encryption key (K1) (step S135).

If it is determined that the encryption process is executed in the “group” mode, encryption key (K2) is created from the group ID of the present user (step S136). The group ID itself may be used as the encryption key (K2). Subsequently, MPEG-2 encoding based on the designated image quality is executed by the aforementioned bit rate control (step S137). The content of encoded data is subjected to encryption using the encryption key (K2) (step S138).

On the other hand, if it is determined that no encryption is executed, only MPEG-2 encoding based on the designated image quality is executed (step S139).

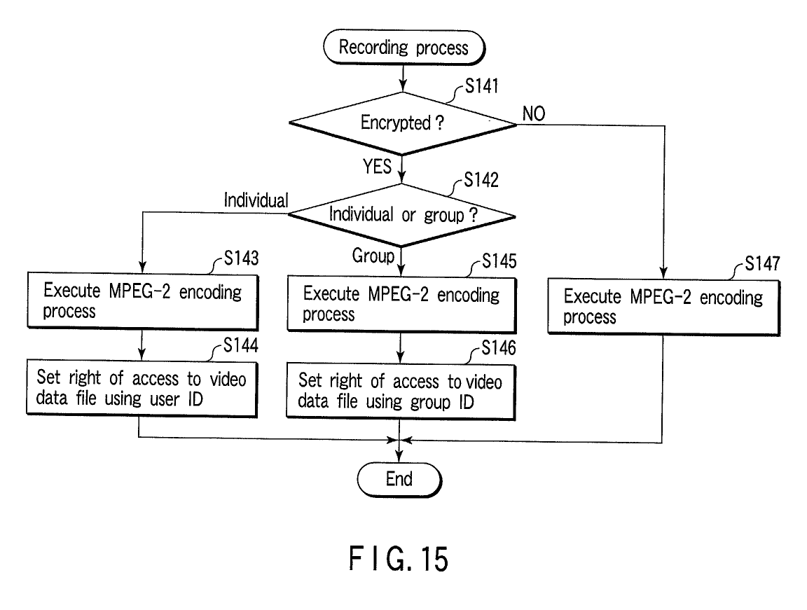

Although the above-described method of encrypting AV data itself is preferable in view of security, individual privacy can be sufficiently protected simply by setting a right of access to recorded data, using, for example, a process in which permission information is attached to, for example, the file header of to-be-recorded AV data for limiting the users who can reproduce the file. FIG. 15 shows this recording process.

At first, it is it is determined, from the contents set in the above-described encryption setup process, whether or not encryption should be executed (step S141). When executing the encryption process, it is also determined whether the encryption process is executed in the “individual”, or “group” mode (step S142). If it is determined that the encryption process is executed with “individual” set, MPEG-2 encoding based on the designated image quality is executed by the aforementioned bit rate control (step S143). Permission information created from the user ID of the present user is attached to the header of the encoded video data file resulting from the encoding process (step S144). Further, if it is determined that the encryption process is executed in the “group” mode, MPEG-2 encoding based on the designated image quality is executed by the aforementioned bit rate control (step S145), and permission information created from the group ID of the present user is attached to the header of the video data file of encoded data resulting from the encoding process (step S146). On the other hand, if it is determined that no encryption is executed, only MPEG-2 encoding based on the designated image quality is executed (step S147). The recorded data resulting from this encoding process is recorded as a video data file that all users can access.

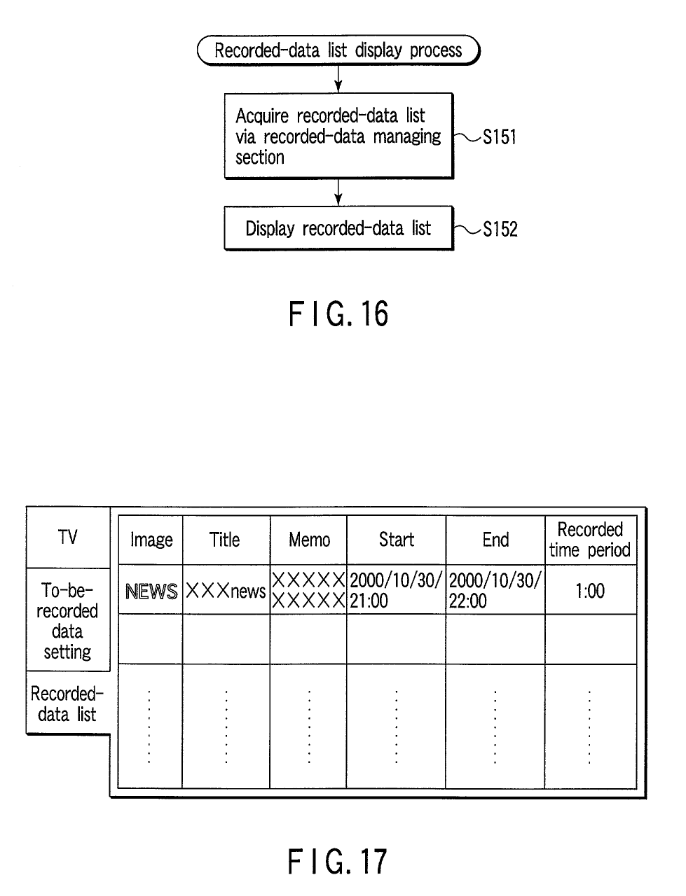

Referring to FIGS. 16 and 17, a description will be given of a function of displaying a list of recorded data or TV programs, which is to be executed when the “recorded-program list” tab 204 has been pushed on the window shown in FIG. 10.

When the “recorded-program list” tab 204 has been pushed, the controlling unit 102 acquires a list of recorded data from the video management information of the recorded data managing unit 107 (step S151), and displays, on the basis of the acquired data, a recorded-data-list window as shown in FIG. 17 on the main window 201 shown in FIG. 10 (step S152). As shown in FIG. 17, the recorded-data-list window includes a still image field for displaying a typical image of each TV program, a title field for displaying the title of each TV program, a memo field for displaying characters that explains the rough contents of each TV program, a record start date/time field, a record finish date/time field and a record period field, etc. The still image, the title and memo are extracted from the electronic TV program guide when they are recorded.

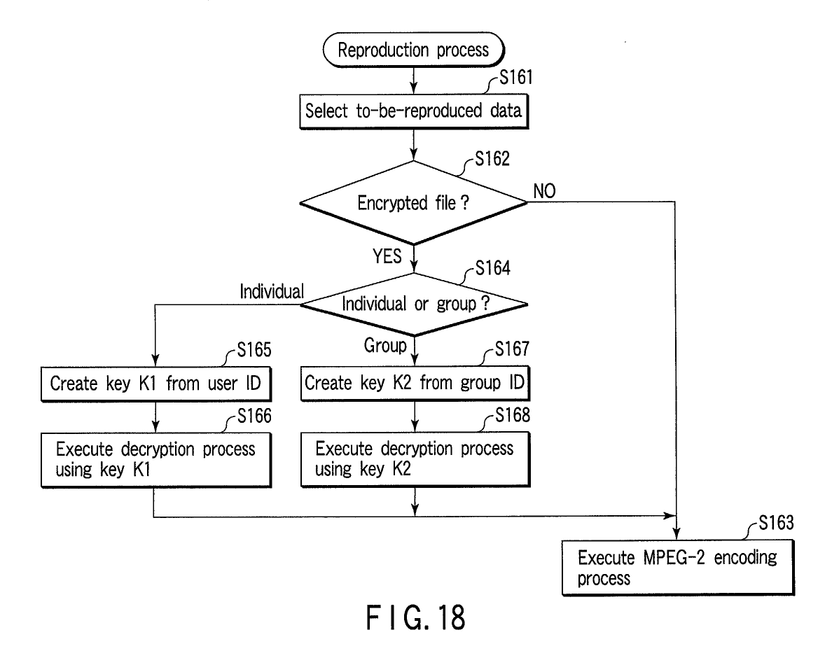

Referring to the flowchart of FIG. 18, a process of reproducing recorded data will be described.

The user selects to-be-reproduced recorded data by, for example, selecting a to-be-reproduced TV program from the recorded-program list window, and pushing the “play” button 210 on the window shown in FIG. 10 (step S161). On the basis of video management information concerning the selected to-be-reproduced data, the controlling unit 102 determines whether or not the selected data is encrypted (step S162). If it is not encrypted (i.e. if the answer at the step S162 is NO), the controlling unit 102 causes the reproducing unit 104 to execute MPEG-2 decoding on the selected data and reproduce the decoded data (step S163).

If, on the other hand, the selected data is encrypted (i.e. if the answer at the step S162 is YES), the controlling unit 102 determines whether the encryption process is executed in the “individual”, or “group” mode (step S164). If it is encrypted in the “individual”, mode, the controlling unit 102 creates key K1 for releasing the encryption, from the user ID of the present user who has demanded the reproduction of the data (step S165). The identification of the user who demanded the reproduction is based on the result of the user identification process executed when the TV application program was activated. It is a matter of course that the user identifying process may be again executed after the “play” button 210 has been pushed. Subsequently, the decoding unit 106 executes decrypting for releasing the encryption, using the created key K1 (step S166), and then the reproducing unit 104 executes MPEG-2 decoding (step S163). If the user who tries to reproduce data is identical to the user who recorded the data, the encryption is normally released and hence the recorded data can be correctly reproduced. However, if the former is not identical to the latter, no encryption is released and no correct reproduction is executed.

Further, if encryption is executed in the “group” mode, the controlling unit 102 creates key K2 for releasing the encryption, from the group ID of the present user who has demanded the reproduction of the data (step S167). Subsequently, the decoding unit 106 executes decoding for releasing the encryption, using the created key K2 (step S166), and then the reproducing unit 104 executes MPEG-2 decoding (step S163). If the user who tries to reproduce data belongs to the same group as the user who recorded the data, the encryption is normally released and hence the recorded data can be correctly reproduced. However, if they do not belong to the same group, no encryption is released and no correct reproduction is executed.

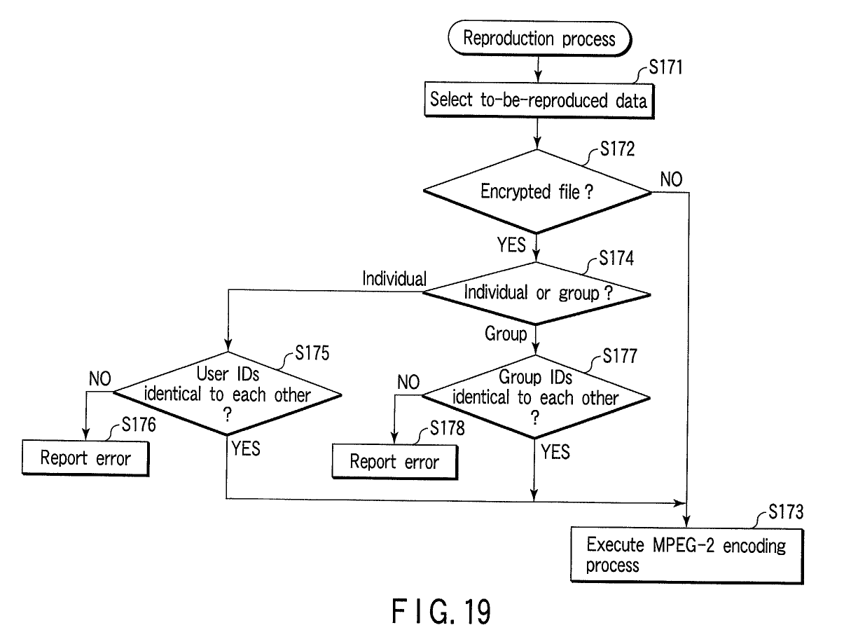

With reference to the flowchart of FIG. 19, a second example of a recorded-data reproducing process will be described. This reproducing process is executed in a case where to-be-recorded data itself is not encrypted but permission information is attached to the to-be-recorded data, when it is recorded.

The user selects to-be-reproduced recorded data by, for example, selecting a to-be-reproduced TV program from the recorded-program list window, and pushing the “play” button 210 on the window shown in FIG. 10 (step S171). The controlling unit 102 refers to video management information concerning the selected to-be-recorded data, or to the file header of the data, thereby determining whether or not the selected data is encrypted (in this case, whether or not there is an access limitation) (step S172). If it is not encrypted (if there is no access limitation), i.e. if the answer at the step S172 is NO, the controlling unit 102 controls the reproducing unit 104 to execute MPEG-2 decoding on the selected data and reproduce the decoded data (step S173).

If, on the other hand, the selected data is encrypted (if there is an access limitation), i.e. if the answer at the step S172 is YES, the controlling unit 102 determines whether the encryption process (access limitation process) is executed in the “individual” or “group” mode (step S174). If it is encrypted in the “individual” mode, the controlling unit 102 compares the user ID of the present user who demanded the reproduction of the data, with the user ID attached to the header of the recorded data, thereby determining whether or not they are identical to each other (step S175). If they are identical to each other (if the answer at the step S175 is YES), the reproduction of the selected data is permitted since the user who tries to reproduce data is identical to the user who recorded the data. Accordingly, the reproducing unit 104 executes MPEG-2 decoding (step S173). If, on the other hand, the user IDs are not identical (if the answer at the step S175 is NO), the reproduction of the selected data is not executed, and the user is informed of an error (step S176).

Further, if encryption (access limitation) is executed in the “group” mode, the controlling unit 102 compares the group ID of the present user who demanded the reproduction of the data, with the group ID attached to the header of the recorded data, thereby determining whether or not they are identical to each other (step S177). If they are identical to each other (if the answer at the step S177 is YES), the reproduction of the selected data is permitted since the user who tries to reproduce data belongs to the same group as the user who recorded the data. Accordingly, the reproducing unit 104 executes MPEG-2 decoding (step S173). If, on the other hand, the group IDs are not identical (if the answer at the step S177 is NO), the reproduction of the selected data is not executed, and the user is informed of an error (step S178).

In the apparatus constructed as above, each to-be-recorded video data item is recorded in a concealed state based on information identifying a user who has demanded its recording. The concealing process may be realized by (1) encrypting video data item to be stored in the storage device, using information identifying the user who has demanded the recording of the video data item, or by (2) attaching, to video data item to be stored in the storage device, permission information for limiting users permitted to reproduce the video data item.

This concealing process enables to-be-stored data demanded by each user to be concealed from the other users. Accordingly, individual privacy concerning each to-be-stored video data item can be protected and further, young people can be prevented from seeing unsound images.

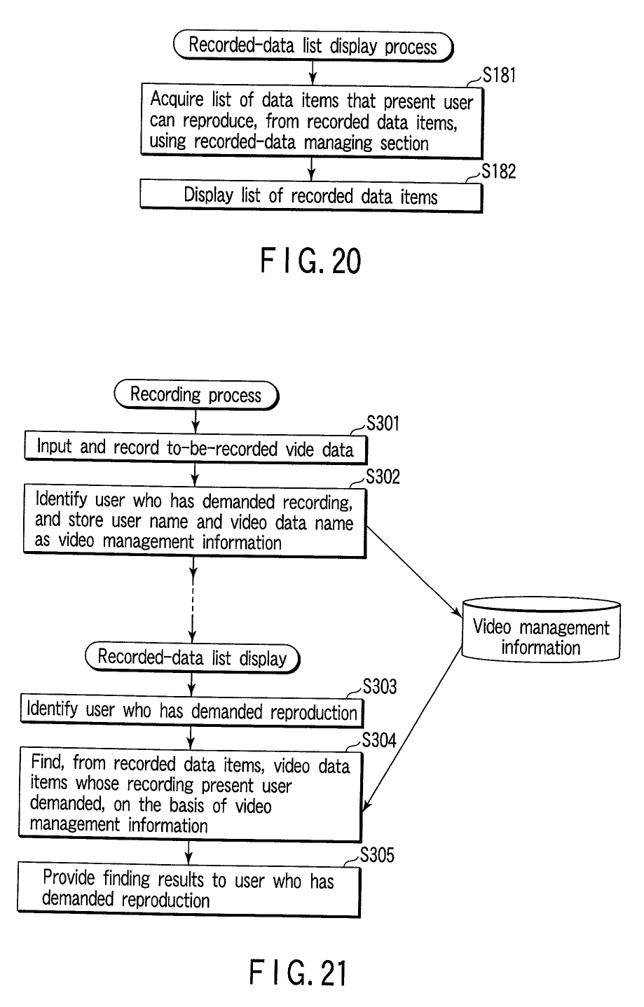

Referring to FIG. 20, a description will be given of a second example of the recorded-data-list display process described above with reference to FIGS. 16 and 17.

In the case of FIGS. 16 and 17, when the “recorded-program list” tab 204 has been pushed, all the recorded data items are displayed in the form of a list. On the other hand, in this example, only recorded data items that the present user can reproduce are displayed in the form of a list in order to protect individual privacy concerning the contents of the recorded data.

Specifically, when the “recorded-program list” tab 204 has been pushed, the controlling unit 102 identifies the present user, and acquires a list of recorded data that the present user can reproduce, from the recorded data managing unit 107 on the basis of the identification result and the video management information of the unit 107 (step S181). The recorded data that the present user can reproduce includes non-encrypted recorded data, data recorded by the present user, and recorded data encrypted using the group ID to which the present user belongs. The same can be said of a case where there is an access limitation. Subsequently, the controlling unit 102 displays a list of recorded data that the present user can reproduce (step S182).

Since the recorded data, which the present user can designate as to-be-reproduced data, is limited to that included in the recorded data list, the process of FIG. 20 can be used as a concealing process to prevent the video data item recorded in the storage device from being reproduced by a person other than a user who has requested the recording of the video data item, in place of the encryption process or the access-right setting process. In other words, the management of only the user name or the group name for each recorded data item enables individual privacy concerning the contents of recorded data to be protected without the encryption process or access right setting process. FIG. 21 shows a process executed in this case.

At first, the controlling unit 102 inputs video data, such as a TV program, whose recording is demanded by each user, and records it in the AV data storage unit 112 (step S301). Subsequently, the controlling unit 102 identifies the user who demanded the recording of the data, and stores, as video management information, the name of the user and the name of the recorded video data in the recorded data managing unit 107 (step S302).

When the present user has demanded the reproduction of a recorded data item, the controlling unit 102 at first identifies the present user, who demanded the reproduction of the data item (step S303). After that, the controlling unit 102 finds the recorded data items having their recording demanded by the present user who demanded the reproduction, from the video data recorded in the AV data storage unit 112, on the basis of video management information stored in the recorded data managing unit 107 (step S304). A list of finding results is displayed for the present user (step S305).

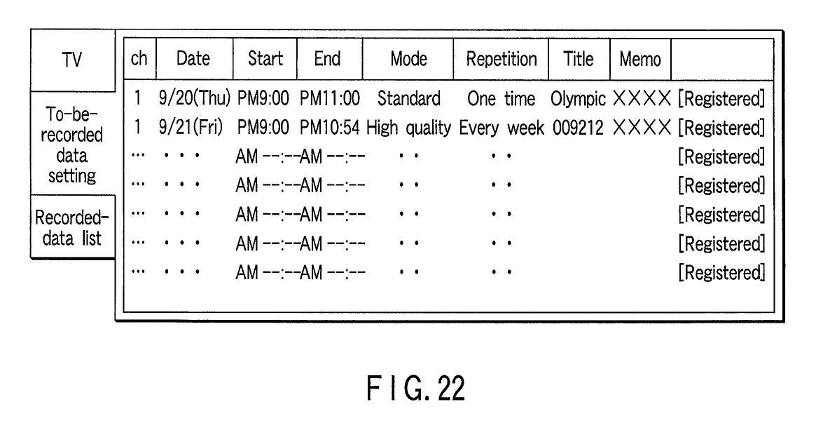

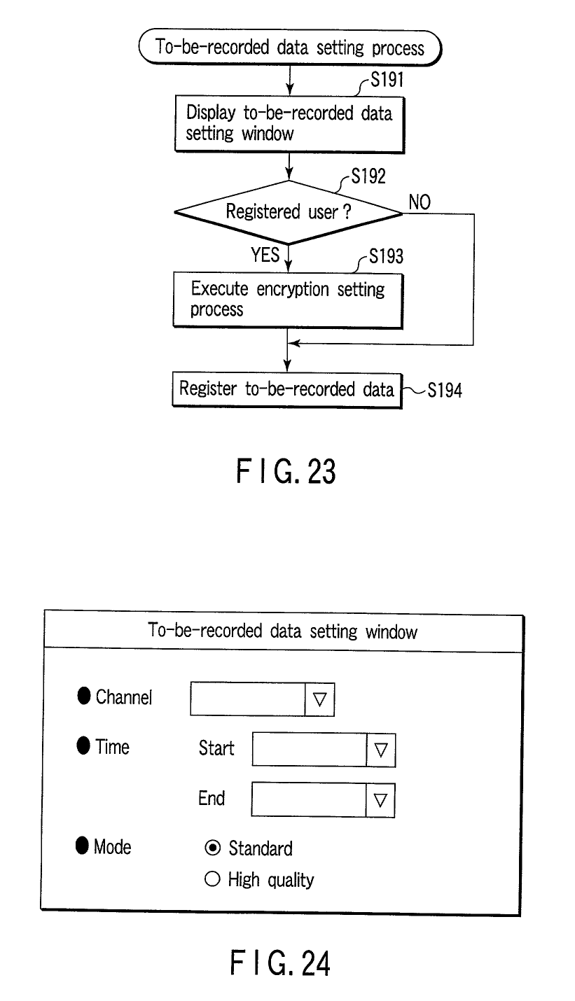

Referring now to FIG. 22, an example window displayed when the “to-be-recorded program” tab 203 has been pushed will be described. When the “to-be-recorded program” tab 203 has been pushed, a window as shown in FIG. 22 is offered to the user. This window shows to-be-recorded TV programs set presently. Specifically, it shows the channel number (ch), the date of recording, the start time of recording, the finish time of recording and the title of each TV program, the image quality mode set for each TV program, a memo concerning each TV program, and information indicative of, for example, whether each TV program should be recorded every week, etc. A new to-be-recorded TV program can be set in a non-use entry by pushing, for example, a “to-be-record data setting” button on the window. FIG. 23 shows the to-be-recorded data setting process (programming of recording).

The controlling unit 102 first displays a to-be-recorded data setting window as shown in FIG. 24 to enable the user to input information in it (step S191). The to-be-recorded data setting window (record reservation window) includes a channel number input field, fields for inputting the record start date/time and the record finish date/time, and a radio button for setting the image quality mode. When necessary information has been input and an “OK button” has been pushed, the controlling unit 102 determines whether or not the present user is included in the registered users having their personal information registered in the user registration information storing unit 111 (step S192). This determination is executed on the basis of the result of the user identifying process executed when the TV application program has been activated. It is a matter of course that the user identifying process may be again executed after the “to-be-recorded data setting” button has been pushed.

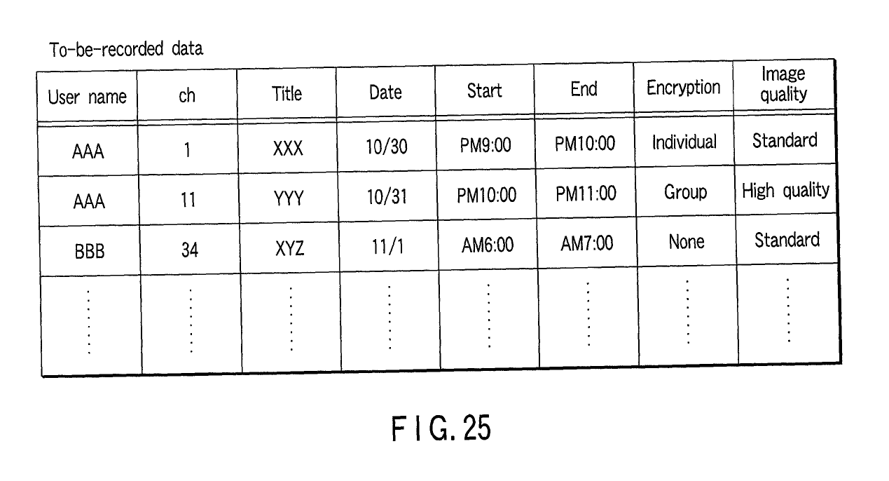

If it is determined that the present user is a registered user (the answer at the step S192 is YES), the controlling unit 102 executes the encryption setting process using the encryption setting window shown in FIG. 12 (step S193). In the encryption setting process, it is set whether or not to-be-recorded data should be encrypted, and also set whether encryption is executed in the “individual”, mode or the “group” mode. After that, information concerning to-be-recorded data is registered on the basis of the contents set in the to-be-recorded data setting window and in the encryption setting window. FIG. 25 shows an example of information concerning to-be-recorded data (record reserved data).

As shown in FIG. 25, the information concerning to-be-recorded data comprises the user name of each user who set the data, the channel number, the title, the record start date/time, the record finish date/time and the image quality mode of each data item, and information as to whether or not each data item is encrypted.

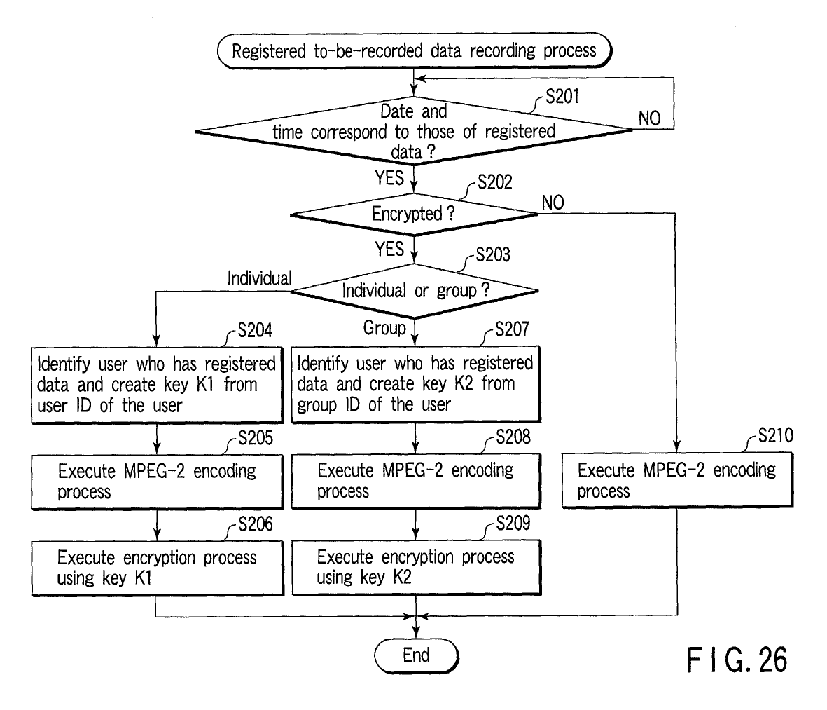

Referring to the flowchart of FIG. 26, a recording process executed on the basis of information concerning to-be-recorded data will be described.

If the date and time is identical to that of to-be-recorded data (if the answer at the step S201 is YES), the controlling unit 102 determines, on the basis of information concerning the to-be-recorded data, whether or not the to-be-recorded data should be encrypted (step S202). If it should be encrypted, the controlling unit 102 further determines whether the encryption should be executed in the “individual” mode or the “group” mode (step S203).

If the “individual”, mode is selected, the encryption key (K1) is created from the user ID of the user who registered the to-be-recorded data (step S204). It is a matter of course that the user ID itself can be used as the encryption key (K1). Subsequently, MPEG-2 encoding based on the designated image quality is executed on the to-be-recorded data by the bit rate control (step S205). The resultant data is subjected to the encryption process using the encryption key (K1) (step S206).

If the “group” mode is selected, the encryption key (K2) is created from the group ID of the user who registered the to-be-recorded data (step S207). It is a matter of course that the group ID itself can be used as the encryption key (K2). Subsequently, MPEG-2 encoding based on the designated image quality is executed on the to-be-recorded data by the bit rate control (step S208). The resultant data is subjected to the encryption process using the encryption key (K2) (step S209).

On the other hand, if no encryption is executed, or if to-be-reproduced video data is limited using the recorded-data-list display function illustrated in FIG. 21, only MPEG-2 encoding based on the designated image quality is executed (step S210).

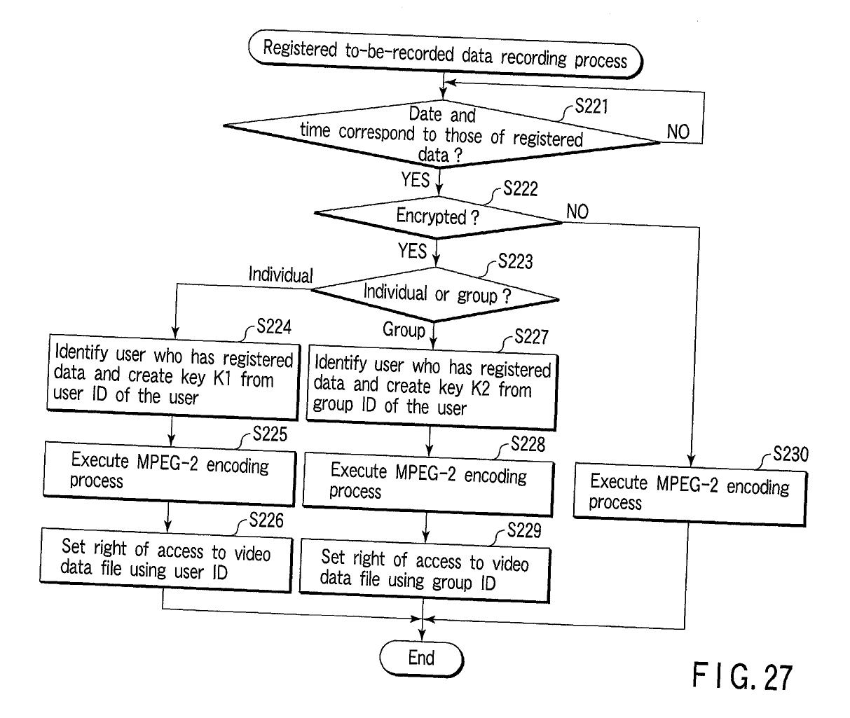

Referring then to the flowchart of FIG. 27, another recording process executed on the basis of information concerning to-be-recorded data will be described. In this case, the right of access to to-be-recorded data is set in place of encrypting the data itself.

If the date and time is identical to that of to-be-recorded data (if the answer at the step S221 is YES), the controlling unit 102 determines, on the basis of information concerning the to-be-recorded data, whether or not the to-be-recorded data should be encrypted (step S222). If it should be encrypted, the controlling unit 102 further determines whether the encryption should be executed in the “individual” mode or the “group” mode (step S223).

If the “individual” mode is selected, the user who registered the to-be-recorded data is identified, thereby acquiring the user ID of the user (step S224). Subsequently, MPEG-2 encoding based on the designated image quality is executed on the to-be-recorded data by the bit rate control (step S225), whereby permission information created from the user ID is attached to the header of the video data file of the resultant to-be-recorded data (step S226). If the “group” mode is selected, the user who registered the to-be-recorded data is identified, thereby acquiring the group ID of the user (step S227). Subsequently, MPEG-2 encoding based on the designated image quality is executed on the to-be-recorded data by the bit rate control (step S228), whereby permission information created from the group ID is attached to the header of the video data file of the resultant to-be-recorded data (step S229).

On the other hand, if no encryption is executed, or if to-be-reproduced video data is limited using the recorded-data-list display function illustrated in FIG. 21, only MPEG-2 encoding based on the designated image quality is executed (step S230), and no permission information is attached to the to-be-recorded data.

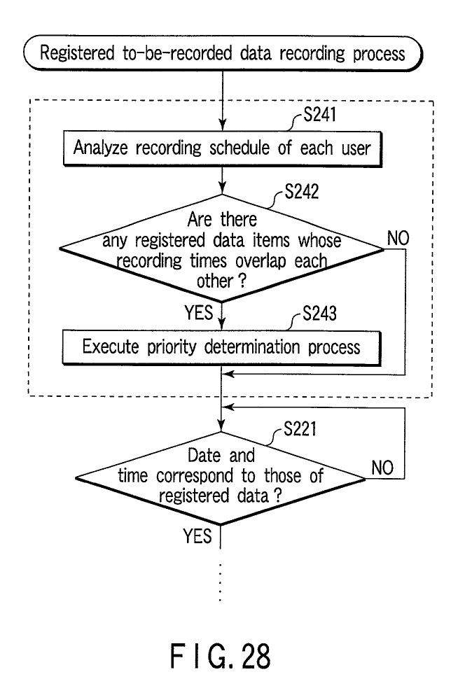

Referring to the flowchart of FIG. 28, a description will be given of priority control executed when the recording times of to-be-recorded data items registered by different users overlap each other.

As described above, since in the computer system of the embodiment, the schedule of to-be-recorded data can be set for each user, it is possible that the recording times of to-be-recorded data items registered by different users may overlap each other. For example, it is possible that user A registers (reserves) the recording of a TV program that starts at 21:00 and finishes at 21:54, and user B registers (reserves) the recording of a TV program that starts at 21:00 and finishes at 21:30. In this case, the priority orders (ranks) of the users A and B are compared, and the TV program registered by the user who has a higher priority is selected. This control can be realized by executing steps S241-S243 shown in FIG. 28 before the step S221 of FIG. 27 (or the step S201 of FIG. 26).

Specifically, at first, the recording schedule of each user is analyzed on the basis of information concerning to-be-recorded data (step S241), thereby determining whether or not to-be-recorded data items whose recording times overlap each other exist (step S242). If such data items exist, the ranks of the users who registered the data items are compared, whereby the data item registered by the user having a higher priority is selected (step S243).

As described above, in the embodiment, the user who demanded the recording of each video data item is identified, and each video data item to be recorded is stored in an concealed state (encrypted state or access limited state) based on information that is assigned to the user who demanded its recording. This concealing process converts video data into a secret form, and enables to-be-recorded data, registered by each user, not to be seen by another user. This means that individual privacy can be protected and further, young people can be prevented from seeing unsound images. The concealing process may be executed after video data is recorded in the storage device.

The same advantage as the above embodiment can be obtained by storing the TV application program in a computer readable recording medium such as a CD-ROM, and causing a computer having a TV tuner function to read it from the recording medium. Moreover, the MPEG-2 encoding/decoding process may be executed using software. The user identification may be executed using the fingerprint sensor 27.

In addition to the personal computers, the TV application program function is also applicable to set top boxes, digital VCRs and home servers, etc.

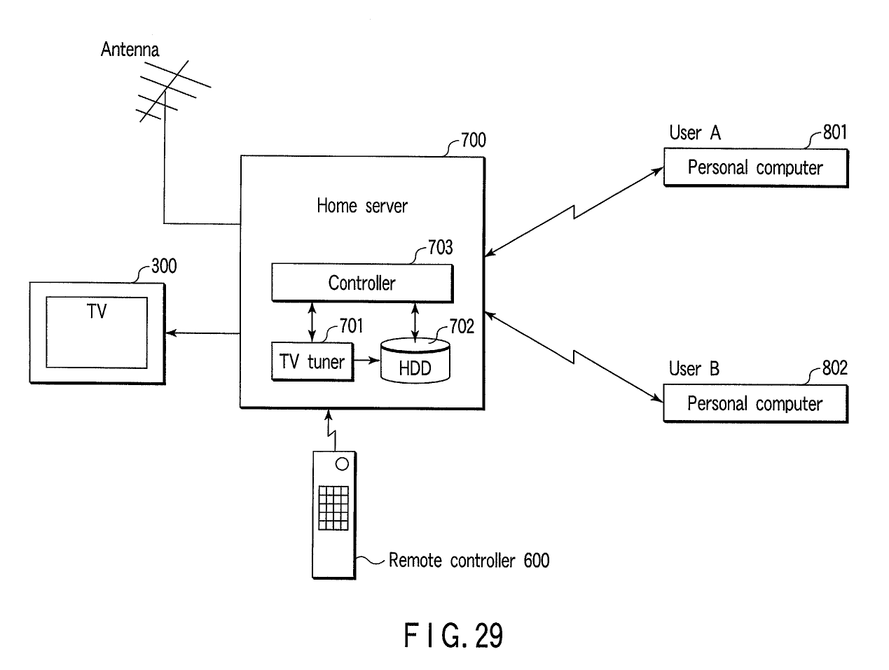

FIG. 29 shows an example of a system structure using a home server. A home server 700 provides services of recording/reproducing video data such as TV programs to user terminals 801 and 802 in accordance with demands from the terminals. Communication between the home server 700 and the user terminals 801 and 802 is executed via a wireless communication interface such as the IEEE802.11 interface. An operation window for recording/reproducing data is provided from the home server 700 to the user terminals 801 and 802. Each user requests to the home server 700 recording/reproducing of video data or setting of to-be-recorded video data, using the operation window displayed on their user terminal. The home server 700 also provides the user terminals 801 and 802 with a recorded-data-list window. When reproducing recorded data, a stream of recorded data to be reproduced is transferred from the home server 700 to the user terminal 801 or 802, and reproduced/displayed thereon. The home server 700 can be operated using a remote control unit 600.

The home server 700 includes a TV tuner 701, an HDD 702 and a controller 703. The controller 703 has the same function as the above-described TV application program, and controls the TV tuner 701 and the HDD 702 so as to input video data having its recording demanded by the user terminal 801 or 802, and to store the input data in the HDD 702. The above-described setting (registration) of to-be-recorded data can also be executed. When recording video data, the controller 703 executes the above-mentioned concealing process. In this concealing process, it is sufficient if to-be-reproduced video data is limited, using the recorded-data-list display function explained with reference to FIG. 21. This is because the HDD 702 of the home server 700 cannot be accessed directly by the file system of each user terminal 801 or 802, unlike the HDD of a personal computer. It is a matter of course that the encryption process or the access limiting process may be used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for recording video data comprising:
a video recorder configured to record video data in a storage device;
means for acquiring a user information of a person who demands the recording of the video data; and
means for executing, using the user information, concealing process to prevent the video data recorded in the storage device from being reproduced by a person other than the person who demands the recording.

2. The apparatus according to claim 1, wherein the executing means includes
means for encrypting the video data to be recorded in the storage device, by an encryption key being based on the user information.

3. The apparatus according to claim 2, further comprising:
means for acquiring a user information of a person who demands reproduction of an encrypted video data recorded in the storage device; and
means for executing a decrypting process to decrypt the encrypted video data designated by the demand for reproduction, by an decryption key being based on the user information of the person who demands reproduction of the encrypted video data.

4. The apparatus according to claim 1, wherein the executing means includes
means for attaching, to a video data to be recorded in the storage device, permission information for limiting users permitted to reproduce the video data, the permission information being created on the user information.

5. The apparatus according to claim 4, further comprising:
means for acquiring a user information of a person who demands reproduction of the video data recorded in the storage device; and
means for determining whether or not the video data designated by the demand for reproduction should be reproduced, on the basis of the user information of the person who demands reproduction, and the permission information attached to the video data designated by the demand for reproduction.

6. The apparatus according to claim 1, further comprising:
means for managing video management information indicating the relationship between each video data item recorded in the storage device and the user who has demanded the recording of the each video data item;
means for identifying a user who has demanded reproduction of each recorded video data item;
means for finding those items of the video data recorded in the storage device, recording of which the user demanded, on the basis of information identifying the user who has demanded reproduction and the video management information; and
means for providing the user who has demanded reproduction with the finding results by the finding means as a list of video data items that can be reproduced by the user.

7. An apparatus for recording video data comprising:
a recorder configured to record video data items demanded to be recorded by users in a storage device;
a managing unit configured to manage video management information that indicates the relationship between the video data items recorded in the storage device and the users who have demanded their recording;
an identifying unit configured to identify a user who has demanded reproduction of each of the video data items recorded in the storage device;
a finding unit configured to find those items of the video data recorded in the storage device, recording of which the user demanded, on the basis of information identifying the user who has demanded reproduction and the video management information; and
a providing unit configured to provide the user who has demanded reproduction with the finding results by the finding unit as a list of video data items that can be reproduced by the user.

8. A method of recording video data in a storage device, the method comprising:
acquiring a user information of a person who demands the recording of the video data; and
executing, using the user information, concealing process to prevent the video data recorded in the storage device from being reproduced by a person other than the person who demands the recording.

9. The method according to claim 8, wherein the executing the concealing process includes encrypting the video data to be recorded in the storage device, by an encryption key being based on the user information.

10. The method according to claim 8, wherein the executing the concealing process includes
attaching, to a video data to be recorded in the storage device, permission information for limiting users permitted to reproduce the video data, the permission information being created on the user information.

11. A method of recording video data items demanded to be recorded by users in a storage device, the method comprising:
managing video management information that indicates the relationship between the video data items recorded in the storage device and the users who have demanded their recording;
identifying a user who has demanded reproduction of each of the video data items recorded in the storage device;
finding those items of the video data recorded in the storage device, recording of which the user demanded, on the basis of information identifying the user who has demanded reproduction and the video management information; and
a providing the user who has demanded reproduction with the finding results by the finding unit as a list of video data items that can be reproduced by the user.
